(19) United States
(12) Patent Application Publication
(10) Pub. No.: US 2026/0268883 A1
(43) Pub. Date: Sep. 10, 2026

(54) SOUND ABSORPTION APPARATUS

(71) Applicant: KABUSHIKI KAISHA TOSHIBA, Kawasaki-shi (JP)

(72) Inventor: Tatsuhiko GOTO, Kawasaki Kanagawa (JP)

(73) Assignee: KABUSHIKI KAISHA TOSHIBA, Kawasaki-shi (JP)

(21) Appl. No.: 19/464,878

(22) Filed: Jan. 30, 2026

(30) Foreign Application Priority Data
Mar. 7, 2025 (JP) 2025-036639

(51) Int. Cl. G10K 11/172

(52) U.S. Cl. CPC G10K 11/172

(57) ABSTRACT

According to one embodiment, a sound absorption apparatus includes a front plate, a diaphragm, a first frame member, a central member, a mesh member, a second frame member, a back plate, and a third frame member. The front plate includes a sound hole. The first frame member is connected to the front plate and the diaphragm to form a first space therebetween. The central member is connected to a central portion of the diaphragm. The mesh member is connected to the central member. The second frame member is connected to the diaphragm and the mesh member to form a second space therebetween. The third frame member is connected to the mesh member and the back plate to form a third space therebetween, which communicates with the second space via the mesh member.

### CROSS-REFERENCE TO RELATED APPLICATIONS

This application is based upon and claims the benefit of priority from Japanese Patent Application No. 2025-036639, filed Mar. 7, 2025, the entire contents of which are incorporated herein by reference.

### FIELD

Embodiments described herein relate generally to a sound absorption apparatus.

### BACKGROUND

A Helmholtz resonator is known as a sound absorption apparatus that reduces sound such as noise. The Helmholtz resonator is a container in which an internal space communicates with an external space via a sound hole. The Helmholtz resonator can generate resonance in the internal space by sound that has entered in the internal space through the sound hole, thereby attenuating vibration energy of the sound at a resonance frequency. The Helmholtz resonator has a one-degree-of-freedom system, and thus has unimodal sound absorption characteristics. The Helmholtz resonator can be applied to a low frequency band depending on the design.

From the viewpoint of widening the band of the sound absorption characteristics, a Helmholtz resonator of a two-degree-of-freedom system has been proposed. The Helmholtz resonator of the two-degree-of-freedom system has a structure in which an elastic plate is added to the Helmholtz resonator of the one-degree-of-freedom system so as to separate the internal space into two spaces. The elastic plate has a one-degree-of-freedom system, the Helmholtz resonator has the one-degree-of-freedom system, and the Helmholtz resonator and the elastic plate are coupled to form the two-degree-of-freedom system. The Helmholtz resonator of the two-degree-of-freedom system has sound absorption characteristics with two separate sound absorption coefficient peaks. A valley characteristic (decrease in the sound absorption coefficient) is generated between the two sound absorption coefficient peaks.

The sound absorption apparatus is required to obtain a sound absorption effect in a wide frequency band.

### BRIEF DESCRIPTION OF DRAWINGS

FIG. 1 is a perspective view showing a sound absorption apparatus according to an embodiment.

FIG. 2 is an exploded view of the sound absorption apparatus shown in FIG. 1.

FIG. 3 is a cross-sectional view of the sound absorption apparatus shown in FIG. 1.

FIG. 4 is a perspective view showing a vibrator shown in FIG. 1.

FIG. 5 is a partially cutaway perspective view showing the vibrator shown in FIG. 1.

FIG. 6 is an exploded view showing the vibrator shown in FIG. 1.

FIG. 7 is a plan view showing an example of a mesh member shown in FIG. 1.

FIG. 8 is a plan view showing a part of the mesh member shown in FIG. 7 in an enlarged manner.

FIG. 9 is a view showing how air is divided by the mesh member shown in FIG. 7.

FIG. 10 is a plan view showing another example of the mesh member shown in FIG. 1.

FIG. 11 is a perspective view showing an acoustic metamaterial according to the embodiment.

FIG. 12 is a perspective view showing a sound absorption unit shown in FIG. 11.

FIG. 13 is an exploded view showing the sound absorption unit shown in FIG. 11.

FIG. 14 is a perspective view showing the sound absorption apparatus according to the embodiment.

FIG. 15 is an exploded view of the sound absorption apparatus shown in FIG. 14.

FIG. 16 is a cross-sectional view of the sound absorption apparatus shown in FIG. 14.

FIG. 17 is an exploded view showing the sound absorption unit according to the embodiment.

FIG. 18 is a perspective view showing the sound absorption apparatus according to the embodiment.

FIG. 19 is an exploded view of the sound absorption apparatus shown in FIG. 18.

FIG. 20 is an exploded view of the sound absorption apparatus shown in FIG. 18.

FIG. 21 is a cross-sectional view of the sound absorption apparatus shown in FIG. 18.

FIG. 22 is a plan view showing two types of front plates used in an example.

FIG. 23 is a diagram showing parameter values of four types of mesh members used in the example.

FIG. 24 is a perspective view showing a sound absorption apparatus according to a first comparative example.

FIG. 25 is a perspective view showing a sound absorption apparatus according to a second comparative example.

FIG. 26 is a schematic diagram showing vibration modes generated in a diaphragm according to the embodiment.

FIG. 27 is a diagram showing settings of a first example.

FIG. 28 is a diagram showing sound absorption characteristics of a sound absorption apparatus according to the first example.

FIG. 29 is a diagram showing the sound absorption characteristics of the sound absorption apparatus according to the first example.

FIG. 30 is a diagram showing settings of a second example.

FIG. 31 is a diagram showing sound absorption characteristics of a sound absorption apparatus according to the second example.

FIG. 32 is a diagram showing the sound absorption characteristics of the sound absorption apparatus according to the second example.

FIG. 33 is a diagram showing a comparison between the sound absorption characteristics of the sound absorption apparatus according to the second example and the sound absorption characteristics of the sound absorption apparatus according to the first example.

FIG. 34 is a diagram showing settings of a third example.

FIG. 35 is a diagram showing sound absorption characteristics of a sound absorption apparatus according to the third example.

FIG. 36 is a diagram showing a comparison between the sound absorption characteristics of the sound absorption apparatus according to the third example and the sound absorption characteristics of the sound absorption apparatus according to the second example.

FIG. 37 is a diagram showing settings of a fourth example.

FIG. 38 is a diagram showing sound absorption characteristics of a sound absorption apparatus according to the fourth example.

FIG. 39 is a diagram showing the sound absorption characteristics of the sound absorption apparatus according to the fourth example.

FIG. 40 is a diagram showing settings of a fifth example.

FIG. 41 is a diagram showing sound absorption characteristics of a sound absorption apparatus according to the fifth example.

### DETAILED DESCRIPTION

According to one embodiment, a sound absorption apparatus includes a front plate, a diaphragm, a first frame member, a central member, a first mesh member, a second frame member, a back plate, and a third frame member. The front plate includes a sound hole. The diaphragm faces the front plate. The first frame member is connected to the front plate and the diaphragm, and forms a first space between the front plate and the diaphragm. The central member is connected to a central portion of the diaphragm. The first mesh member includes a plurality of openings, and is connected to the central member. The second frame member is connected to the diaphragm and the first mesh member, and forms a second space between the diaphragm and the first mesh member. The back plate faces the first mesh member. The third frame member is connected to the first mesh member and the back plate, and forms a third space communicating with the second space via the openings of the first mesh member between the first mesh member and the back plate.

According to one embodiment, there is provided a sound absorption apparatus capable of absorbing sound in a wide frequency band.

Hereinafter, embodiments will be described with reference to the accompanying drawings.

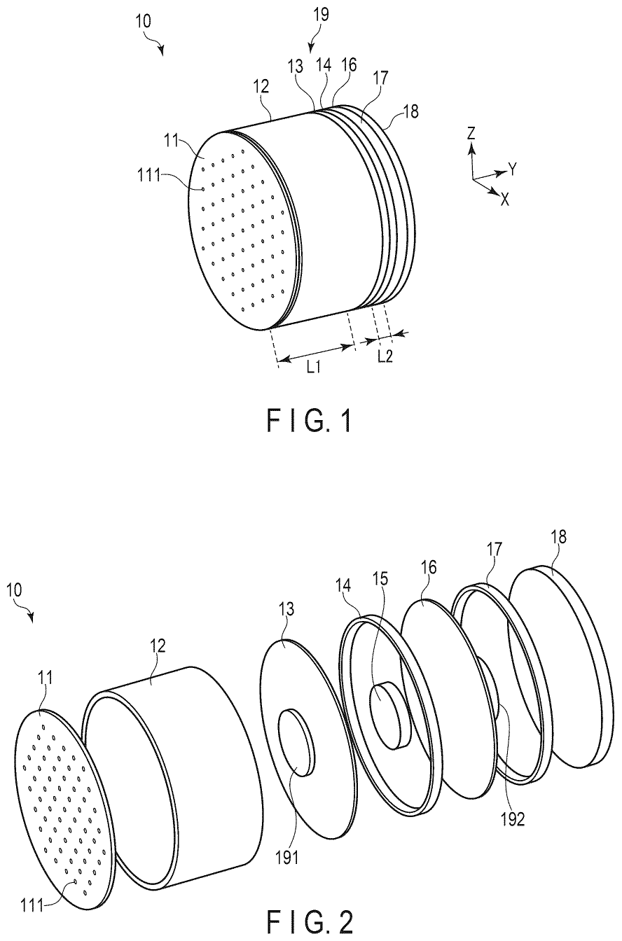

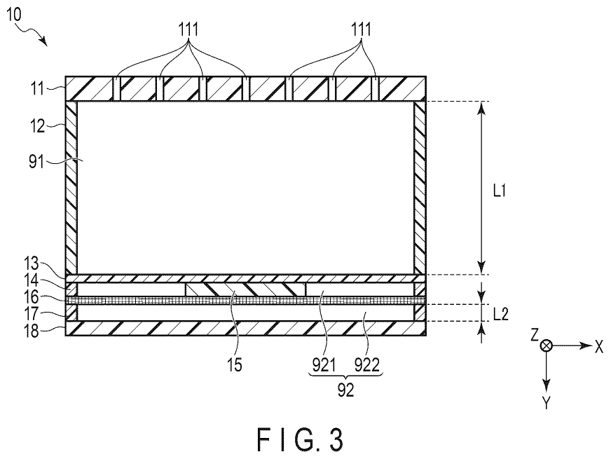

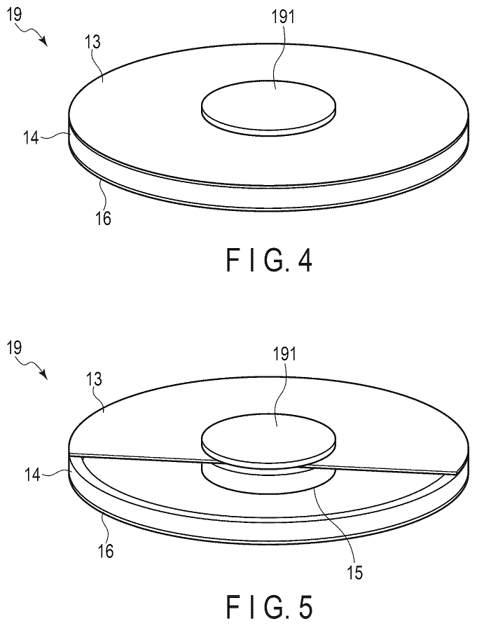

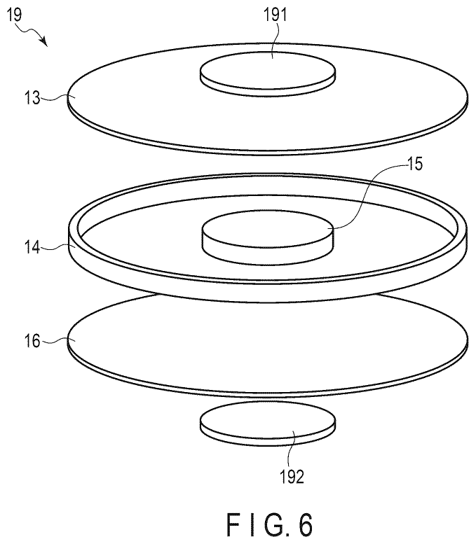

FIG. 1 schematically shows a sound absorption apparatus 10 according to an embodiment, FIG. 2 schematically shows the sound absorption apparatus 10 in a disassembled state, FIG. 3 schematically shows a cross section of the sound absorption apparatus 10, FIG. 4 schematically shows a vibrator 19 included in the sound absorption apparatus 10, FIG. 5 schematically shows the vibrator 19 in a partially cutaway state, and FIG. 6 schematically shows the vibrator 19 in a disassembled state. The sound absorption apparatus 10 is configured to absorb sound generated in an external space. For example, the sound absorption apparatus 10 is used to reduce noise.

As shown in FIGS. 1 to 6, the sound absorption apparatus 10 includes a front plate 11, a frame member 12, a diaphragm 13, a frame member 14, a central member 15, a mesh member 16, a frame member 17, a back plate 18, and magnets 191 and 192. The diaphragm 13, the frame member 14, the central member 15, the mesh member 16, and the magnets 191 and 192 form the vibrator 19. In FIG. 3, the magnets 191 and 192 are not shown.

The front plate 11 is a perforated plate. For example, the front plate 11 is a circular flat plate provided with a plurality of sound holes 111. The number of sound holes 111 provided in the front plate 11 may be one. The diameter of the sound hole 111 is, for example, 0.1 mm or more and 20 mm or less. For description, an XYZ orthogonal coordinate system is introduced. A Y axis is defined in a direction perpendicular to a main surface of the front plate 11, and an X axis and a Z axis are defined in a direction parallel to the main surface of the front plate 11. In addition, for description, the front plate 11 is defined as an upper side, and the back plate 18 is defined as a lower side. Hereinafter, thicknesses and lengths refer to dimensions in the Y-axis direction (direction parallel to the Y axis). In addition, a planar shape refers to a shape on the XZ plane.

The frame member 12 is, for example, a cylindrical member. In FIGS. 1 and 3, L1 represents the length of the frame member 12. The vibrator 19 is in, for example, a columnar shape as a whole. The vibrator 19 face the front plate 11 in the Y-axis direction. In other words, the vibrator 19 is provided opposite to front plate 11 in the Y-axis direction. The frame member 12 is located between the front plate 11 and the vibrator 19. The frame member 17 is, for example, a cylindrical member. In FIGS. 1 and 3, L2 represents the length of the frame member 17. The back plate 18 is, for example, a circular flat plate. The back plate 18 faces the vibrator 19 in the Y-axis direction. In other words, the back plate 18 is provided opposite to the vibrator 19 in the Y-axis direction. The frame member 17 is located between the vibrator 19 and the back plate 18. The vibrator 19 is arranged between the front plate 11 and the back plate 18.

The diaphragm 13 is, for example, a circular membrane or film. The frame member 14 is, for example, an annular (cylindrical) member. The central member 15 is, for example, a columnar member. Alternatively, the central member 15 may be an annular member. The thickness of the central member 15 is equal to the length of the frame member 14. The central member 15 is located inside the frame member 14. The mesh member 16 is, for example, a circular elastic member provided with a plurality of holes (also referred to as openings) through which air passes. The mesh member 16 faces the diaphragm 13 in the Y-axis direction. In other words, the mesh member 16 is provided opposite to the diaphragm 13 in the Y-axis direction. The frame member 14 and the central member 15 are located between the diaphragm 13 and the mesh member 16. The mesh member 16 supports the central member 15 so as to vibrate with respect to the frame member 14. The central member 15 is supported by the mesh member 16 so as to vibrate in the Y direction.

The diaphragm 13 is connected to the frame member 14 so as to close a first opening end of the frame member 14, and the mesh member 16 is connected to frame member 14 so as to close a second opening end of the frame member 14. The diaphragm 13, the frame member 14, and the mesh member 16 form an internal space 921. The central member 15 has an upper surface connected to a central portion of the diaphragm 13 and a lower surface connected to a central portion of the mesh member 16. The central member 15 applies a mass load to the diaphragm 13. The diaphragm 13, the central member 15, and the mesh member 16 are provided between the magnets 191 and 192, and the central member 15 is connected to the diaphragm 13 and the mesh member 16 by a magnetic force acting between the magnets 191 and 192.

The front plate 11 is connected to the frame member 12 so as to close a first opening end of the frame member 12. The vibrator 19 (specifically, the diaphragm 13) is connected to the frame member 12 so as to close a second opening end of the frame member 12. The vibrator 19 is separated from the front plate 11 by the length L1. The frame member 12, the front plate 11, and the diaphragm 13 form an internal space 91. The internal space 91 communicates with an external space via the sound holes 111. The sound holes 111 function as paths through which sound generated in the external space enters the internal space 91 of the sound absorption apparatus 10.

The vibrator 19 (specifically, the mesh member 16) is connected to the frame member 17 so as to close a first opening end of the frame member 17. The back plate 18 is connected to the frame member 17 so as to close a second opening end of the frame member 17. The frame member 17 and the back plate 18 may be integrally molded. The mesh member 16 is separated from the back plate 18 by the length L2. The frame member 17, the mesh member 16, and the back plate 18 form an internal space 922. The internal space 922 communicates with the internal space 921 via the holes of the mesh member 16. The internal spaces 921 and 922 are collectively referred to as an internal space 92. The internal space 92 is a closed space surrounded by the diaphragm 13, the frame member 14, the frame member 17, and the back plate 18. The internal space 92 is divided into the internal spaces 921 and 922 by the mesh member 16.

An outer diameter of the diaphragm 13 is equal to outer diameters of the frame member 12 and the frame member 14, and an outer edge portion of the diaphragm 13 is sandwiched between the frame member 12 and the frame member 14. An outer diameter of the mesh member 16 is equal to outer diameters of the frame member 14 and the frame member 17, and an outer edge portion of the mesh member 16 is sandwiched between the frame member 14 and the frame member 17.

The front plate 11, the frame member 12, the frame member 14, the central member 15, the mesh member 16, the frame member 17, and the back plate 18 may be made of a synthetic resin, a metal material, or the like. The diaphragm 13 may be made of an elastic material such as polyvinyl chloride (PVC), silicon rubber, fluororubber, silicone rubber, acrylic rubber, ethylene propylene rubber, ethylene vinyl acetate copolymer, and the like.

A connection between the two components, such as a connection between the front plate 11 and the frame member 12, may be implemented by adhesion using an adhesive or the like, or may be implemented by fixation using a combination of a bolt and a nut or a pair of magnets. In the example described here, the central member 15 is attached to the diaphragm 13 and the mesh member 16 using the magnets 191 and 192. The central member 15 may be attached to the diaphragm 13 and the mesh member 16 using an adhesive. In this case, the magnets 191 and 192 may be removed from the sound absorption apparatus 10.

The vibrator 19 vibrates by receiving sound entering the internal space 91 through the sound holes 111. Specifically, the diaphragm 13 vibrates by receiving the sound entering the internal space 91, and then the central member 15 vibrates following the vibration of the diaphragm 13. The vibrator 19 has two sound absorption characteristics. A first sound absorption characteristic is obtained by the central member 15 vibrating in the Y-axis direction and the diaphragm 13 also vibrating in accordance with the vibration of the central member 15. A second sound absorption characteristic is obtained by diaphragm vibration, that is, vibration of the diaphragm 13 itself. A partial region of the diaphragm 13 is attached to the central member 15, and diaphragm vibration is possible in the remaining region of the diaphragm 13. The second sound absorption characteristic is generated in a higher frequency than the first sound absorption characteristic. In the embodiment, the second sound absorption characteristic is mainly utilized.

In the internal space 92, air moves between the internal space 921 and the internal space 922 through the openings of the mesh member 16 in accordance with the vibration of the diaphragm 13. For example, when the diaphragm 13 deforms downward, a part of air in the internal space 921 moves into the internal space 922, and when the diaphragm 13 deforms upward, a part of air in the internal space 922 moves into the internal space 921.

The sound absorption apparatus 10 having the above-described configuration functions as a Helmholtz resonator of a two-degree-of-freedom system. Specifically, the structure forming the internal space 91 (specifically, the front plate 11, the frame member 12, and the vibrator 19) functions as a Helmholtz resonator of a one-degree-of-freedom system, and the vibrator 19 adds a one-degree-of-freedom system. The Helmholtz resonator and the vibrator 19 are coupled to form a two-degree-of-freedom system. The Helmholtz resonator of the two-degree-of-freedom system has sound absorption characteristics with two separate sound absorption coefficient peaks.

In the example shown in FIGS. 1 to 3, the sound absorption apparatus 10 is in a cylindrical shape as a whole, and the planar shape of the internal space is circular. The planar shape of each component and the planar shape of the internal space are not limited to a circular shape, and may be a polygonal shape or a figure surrounded by an arbitrary closed curve. In addition, the planar shape of the internal space and the area thereof may change with respect to the Y-axis direction.

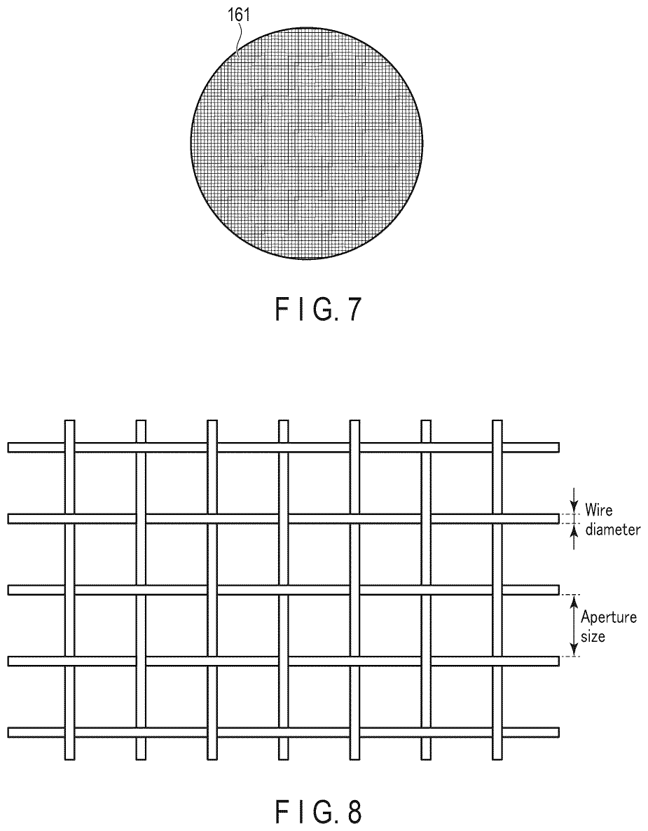

FIG. 7 schematically shows a mesh member 161 that is an example of the mesh member 16, and FIG. 8 shows a part of the mesh member 161 in an enlarged manner. The mesh member 161 shown in FIGS. 7 and 8 is a woven wire mesh in which metal lines are woven. The weaving type is not limited to a plain weave as shown in FIG. 8, and may be a twill weave or the like. When the mesh member 161 vibrates, inter-wire friction (also called friction between wires) is generated, which causes damping (dissipated energy). The inter-wire friction indicates friction between wires.

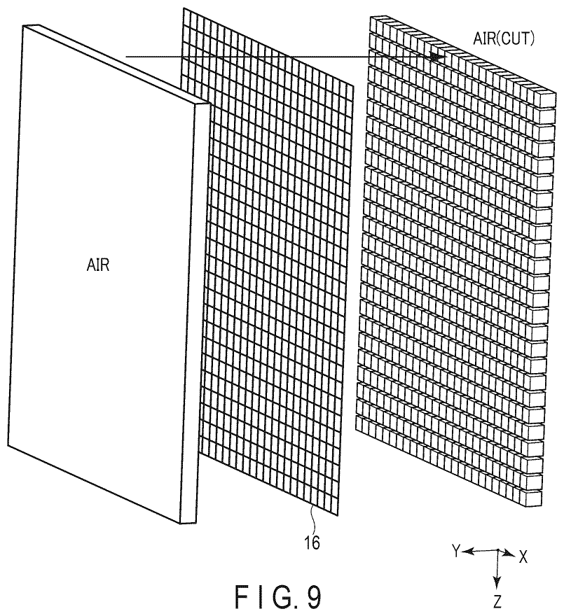

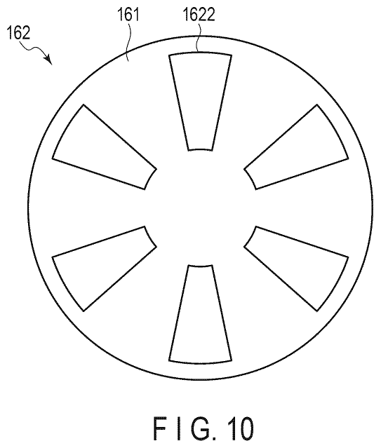

The mesh member 16 elastically supports the diaphragm 13 via the central member 15. In a case where the mesh member 161 is used as the mesh member 16, the support of the diaphragm 13 by the mesh member 16 is viscoelastic support due to the inter-wire friction. In addition, in the internal space 92, air passes through the openings of the mesh member 16 during the movement between the internal space 921 and the internal space 922. As shown in FIG. 9, air is divided by the mesh member 16 and an air viscous resistance is added due to the air division. The supporting viscoelasticity and the air viscous resistance lead to suppression of a valley characteristic between the two sound absorption coefficient peaks.

In the mesh member 161, the supporting viscoelasticity and the air viscous resistance can be adjusted based on the fineness of the mesh. This facilitates adjustment of the effect of valley suppression. Woven wire meshes with various mesh finenesses are commercially available, and it is possible to select a woven wire mesh that can obtain desired sound absorption characteristics from a commercial product line-up.

The mesh fineness depends on a wire diameter. As the wire diameter increases, the inter-wire friction increases, which increases the viscosity in viscoelastic support and the effect of valley suppression. In addition, as the wire diameter increases, the obstacle increases and the passing distance also increases, which increases the air viscous resistance and the effect of valley suppression.

FIG. 10 schematically shows a mesh member 162 that is another example of the mesh member 16. The mesh member 162 shown in FIG. 10 is formed by hollowing out a part of the mesh member 161. A hole 1622 of the mesh member 162 is formed by hollowing out a part of the mesh member 161.

In addition, the mesh member 16 is not limited to a woven wire mesh, and fixed wire mesh (welded wire mesh, expanded metal, etc.) can also be used. In a case where the fixed wire mesh is used as the mesh member 16, viscoelastic support cannot be obtained because the mesh materials are fixed to each other, but the effect of suppressing the valley characteristic can be obtained because the air viscous resistance can be added.

As described above, in the sound absorption apparatus 10, the mesh member 16 viscoelastically supports the diaphragm 13 and adds the air viscous resistance in the internal space 92. This makes it possible to suppress the valley characteristic between the two sound absorption coefficient peaks. Note that, in a case where a member that generates inter-wire friction such as the woven wire mesh is used as the mesh member 16, the support of the diaphragm 13 by the mesh member 16 is viscoelastic support, which can further suppress the valley characteristic. The suppression of the valley characteristic makes it possible to effectively absorb sound in a wide frequency band. Therefore, the sound absorption apparatus 10 can absorb sound in a wide frequency band.

In the sound absorption apparatus 10, the diaphragm 13 can be made of a heat-resistant material such as silicon rubber, and all the other components can be made of a metal material. That is, it is possible to enhance the heat resistance of the sound absorption apparatus 10. Therefore, use in a high-temperature environment is possible.

The sound absorption apparatus 10 can be used as each of a plurality of sound absorption units forming an acoustic metamaterial. The acoustic metamaterial may be referred to as a sound absorption apparatus or a sound absorption system.

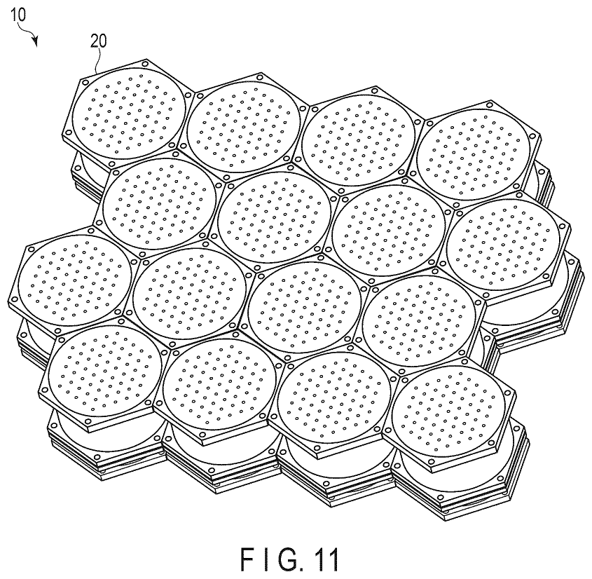

FIG. 11 schematically shows an acoustic metamaterial 100 according to the embodiment. As shown in FIG. 11, the acoustic metamaterial 100 includes a plurality of sound absorption units 20. The sound absorption units 20 are arranged periodically (in a honeycomb shape in this example). The sound absorption units 20 can be fixed to each other using, for example, a band (not shown). Each of the sound absorption units 20 has the structure equivalent to that of the sound absorption apparatus 10 described with reference to FIGS. 1 to 6. The sound absorption unit 20 is in a hexagonal columnar shape as a whole in order to be arranged in a honeycomb shape.

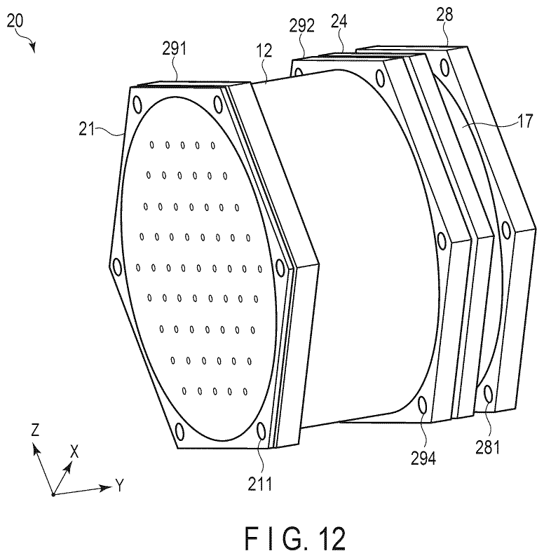

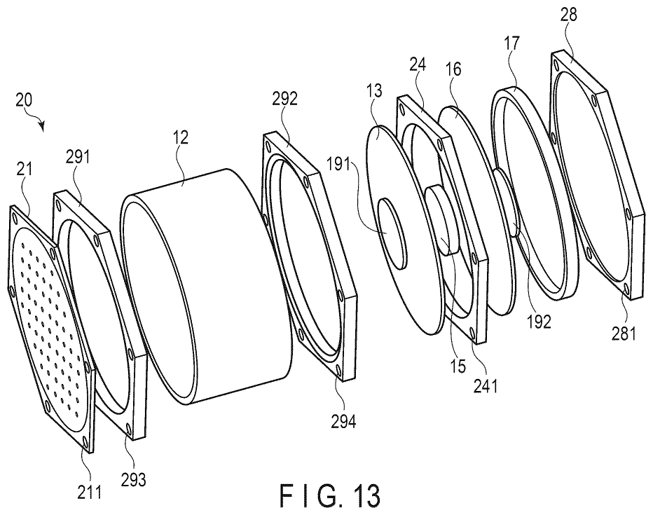

FIG. 12 schematically shows the sound absorption unit 20, and FIG. 13 schematically shows the sound absorption unit 20 in a disassembled state. In FIGS. 12 and 13, the same components as those shown in FIGS. 1 to 3 are denoted by the same reference numerals to omit redundant description as appropriate.

As shown in FIGS. 12 to 13, the sound absorption unit 20 includes a front plate 21, a frame member 12, a diaphragm 13, a frame member 24, a central member 15, a mesh member 16, a frame member 17, a back plate 28, magnets 191 and 192, and frame members 291 and 292.

The front plate 21 corresponds to a front plate 11 to which a hexagonal outer frame is added. An outer edge portion of the front plate 21 is provided with six holes 211 for inserting bolts. The frame member 24 corresponds to a frame member 14 to which a hexagonal outer frame is added. An outer edge portion of the frame member 24 is provided with six holes 241 for inserting the bolts. The back plate 28 corresponds to a back plate 18 to which a hexagonal outer frame is added. An outer edge portion of the back plate 28 is provided with six holes 281 for inserting the bolts.

The frame member 291 is a member for positioning the front plate 21 with respect to the frame member 12. An outer edge portion of the frame member 291 is provided with six holes 293 for inserting the bolts. The frame member 292 is a member for positioning the frame member 24 with respect to the frame member 12. An outer edge portion of the frame member 292 is provided with six holes 294 for inserting the bolts. Note that, for easier positioning of the frame member 12, the frame member 291 and the frame member 292 may be provided with a groove into which the frame member 12 is fitted.

The front plate 21, the frame member 12, the diaphragm 13, the frame member 24, the mesh member 16, the frame member 17, and the back plate 28 are fixed to each other by screwing nuts into the bolts while the bolts are inserted into the hole 211, the hole 293, the hole 294, the hole 241, and the hole 281.

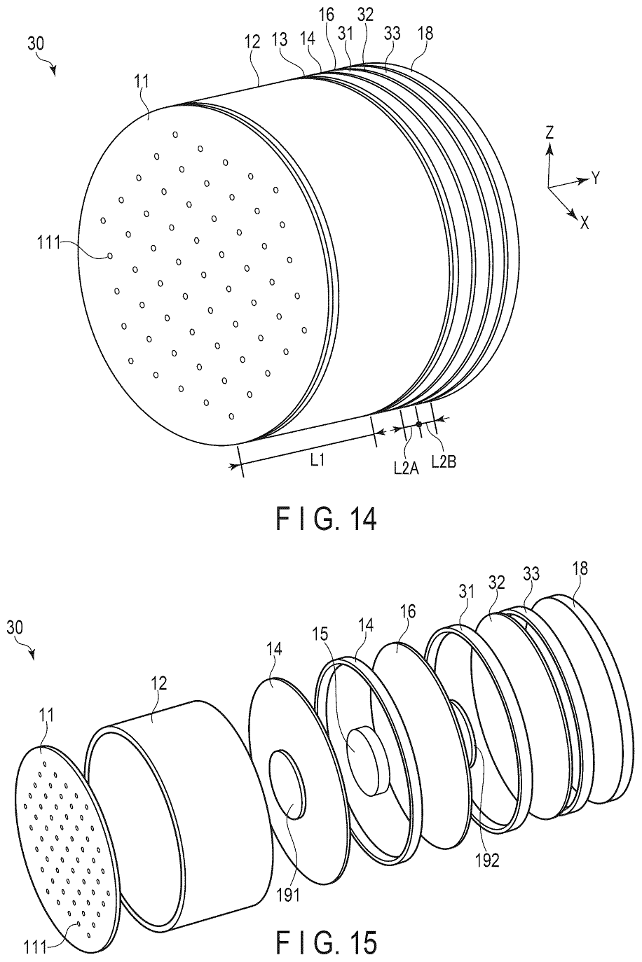

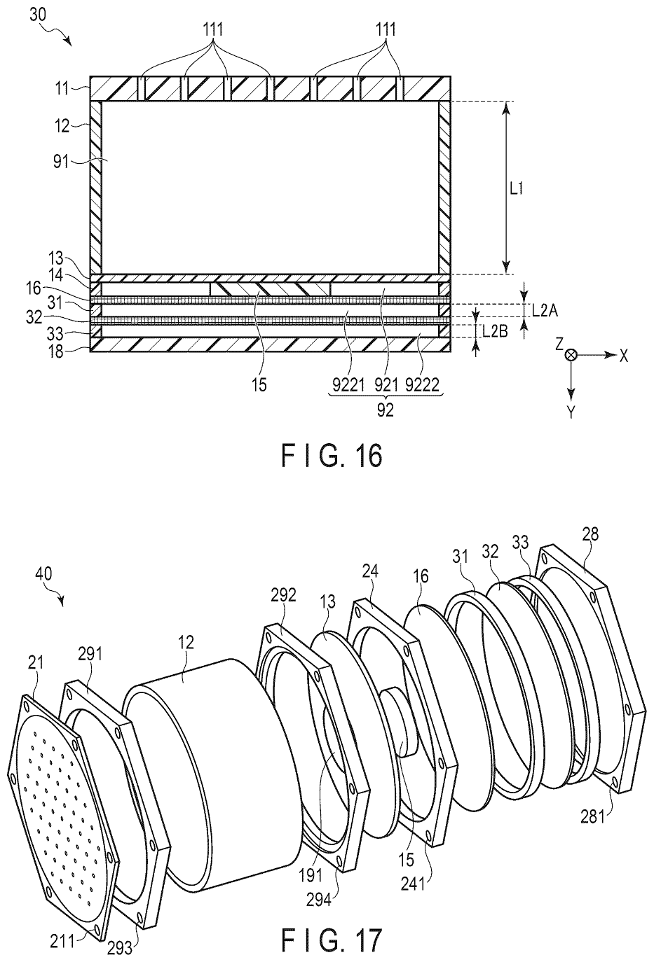

FIG. 14 schematically shows a sound absorption apparatus 30 according to the embodiment, FIG. 15 schematically shows the sound absorption apparatus 30 in a disassembled state, and FIG. 16 schematically shows a cross section of the sound absorption apparatus 30. In FIGS. 14 to 16, the same components as those shown in FIGS. 1 to 3 are denoted by the same reference numerals to omit redundant description as appropriate.

As shown in FIGS. 14 to 16, the sound absorption apparatus 30 includes a front plate 11, a frame member 12, a diaphragm 13, a frame member 14, a central member 15, a mesh member 16, a frame member 31, a mesh member 32, a frame member 33, a back plate 18, and magnets 191 and 192.

The frame members 31 and 33 are, for example, cylindrical members. In FIGS. 14 and 16, L2A represents a length of the frame member 31, and L2B represents a length of the frame member 33.

The mesh member 32 is, for example, a circular member provided with a plurality of holes through which air passes. The mesh member 32 may have the same structure as that of the mesh member 16. For example, the mesh member 161 shown in FIG. 7 may be used as each of the mesh members 16 and 32. Alternatively, the mesh member 32 may have a different structure from that of the mesh member 16. For example, the mesh member 161 shown in FIG. 7 having different wire diameters may be used as the mesh members 16 and 32, or the mesh member 161 shown in FIG. 7 may be used as the mesh member 16, while the mesh member 162 shown in FIG. 10 is used as the mesh member 32.

The mesh member 16 is connected to the frame member 31 so as to close a first opening end of the frame member 31. The mesh member 32 is connected to the frame member 31 so as to close a second opening end of the frame member 31. The mesh member 16 is separated from the mesh member 32 by the length L2A. The frame member 31, the mesh member 16, and the mesh member 32 form an internal space 9221. The internal space 9221 communicates with the internal space 921 via holes of the mesh member 16.

The mesh member 32 is connected to the frame member 33 so as to close a first opening end of the frame member 33. The back plate 18 is connected to the frame member 33 so as to close a second opening end of the frame member 33. The frame member 33 and the back plate 18 may be integrally molded. The mesh member 32 is separated from the back plate 18 by the length L2B. The frame member 33, the mesh member 32, and the back plate 18 form an internal space 9222. The internal space 9222 communicates with the internal space 9221 via holes of the mesh member 32. In this example, the internal spaces 921, 9221, and 9222 are collectively referred to as an internal space 92. The internal space 92 is a closed space surrounded by the diaphragm 13, the frame member 14, the frame member 31, the frame member 33, and the back plate 18. The internal space 92 is divided into the internal spaces 921, 9221, and 9222 by the mesh members 16 and 32.

An outer diameter of the mesh member 32 is equal to outer diameters of the frame member 31 and the frame member 33, and an outer edge portion of the mesh member 32 is sandwiched between the frame member 31 and the frame member 33.

As described above, the sound absorption apparatus 30 has a structure in which the frame member 17 of the sound absorption apparatus 10 is divided into two and the mesh member 32 is provided therebetween. The internal space 922 (FIG. 3) is divided into the two internal spaces 9221 and 9222 by the mesh member 32. Since the air viscous resistance is further increased by providing the mesh member 32, the valley characteristic can be suppressed more than in the sound absorption apparatus 10.

The sound absorption apparatus 30 can be used as each of a plurality of sound absorption units forming the acoustic metamaterial.

FIG. 17 schematically shows a sound absorption unit 40 according to the embodiment in a disassembled state. In FIG. 17, the same components as those shown in FIGS. 12 to 13 are denoted by the same reference numerals to omit redundant description as appropriate.

As shown in FIG. 17, the sound absorption unit 40 includes a front plate 21, a frame member 12, a diaphragm 13, a frame member 24, a central member 15, a mesh member 16, a frame member 31, a mesh member 32, a frame member 33, a back plate 18, and frame members 291 and 292. The sound absorption unit 40 is obtained by replacing the frame member 17 with a combination of the frame member 31, the mesh member 32, and the frame member 33 in the sound absorption unit 20. Therefore, a detailed description of the sound absorption unit 40 is omitted.

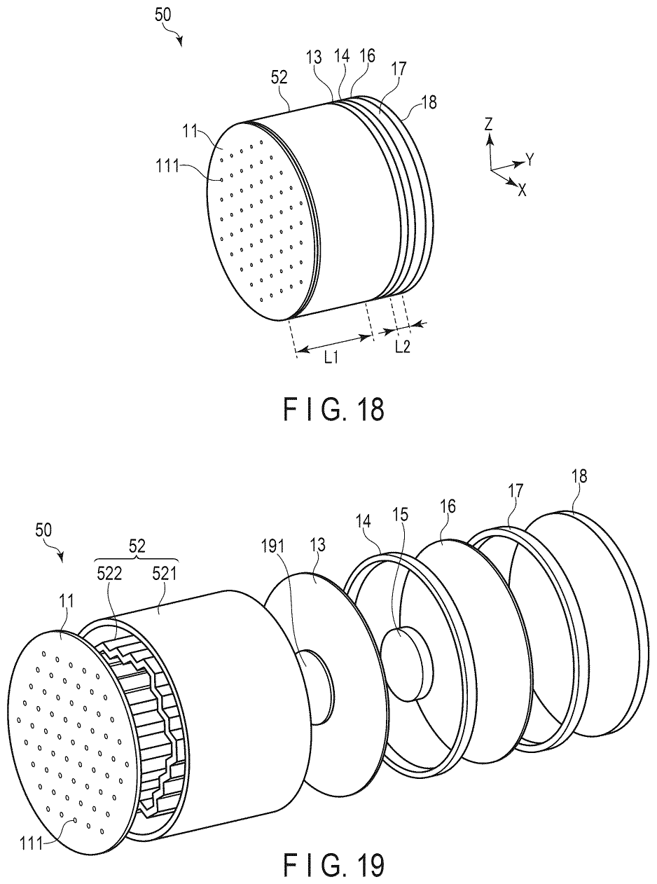

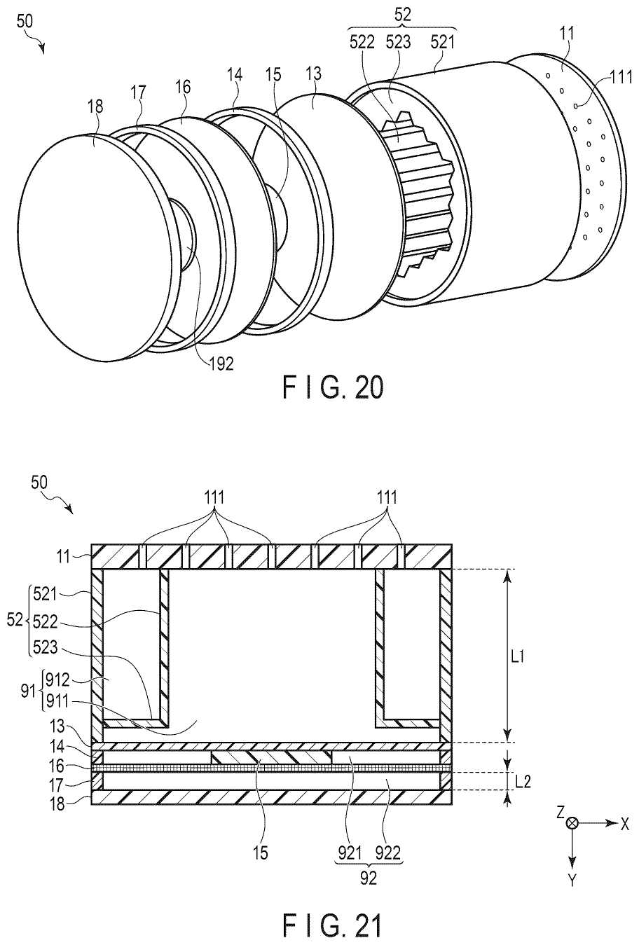

FIG. 18 schematically shows a sound absorption apparatus 50 according to the embodiment, FIGS. 19 and 20 schematically show the sound absorption apparatus 50 in a disassembled state, and FIG. 21 schematically shows a cross section of the sound absorption apparatus 50. In FIGS. 18 to 21, the same components as those shown in FIGS. 1 to 3 are denoted by the same reference numerals to omit redundant description.

As shown in FIGS. 18 to 21, the sound absorption apparatus 50 includes a front plate 11, a frame member 52, a diaphragm 13, a frame member 14, a central member 15, a mesh member 16, a frame member 17, a back plate 18, and magnets 191 and 192. The diaphragm 13, the frame member 14, the central member 15, the mesh member 16, and the magnets 191 and 192 form a vibrator 19. The sound absorption apparatus 50 is obtained by replacing the frame member 12 with the frame member 52 in the sound absorption apparatus 10.

The frame member 52 is, for example, a cylindrical member. The frame member 52 forms an internal space 91 between the front plate 11 and the vibrator 19. The front plate 11 is connected to the frame member 52 so as to close a first opening end of the frame member 52. The diaphragm 13 is connected to the frame member 52 so as to close a second opening end of the frame member 52. The diaphragm 13 is separated from the front plate 11 by a length L1. The internal space 91 communicates with an external space via sound holes 111.

The frame member 52 includes an outer frame 521, an inner frame 522 provided inside the outer frame 521, and a bottom plate 523. The inner frame 522 and the bottom plate 523 are collectively referred to as a space division member or a slit member. The outer frame 521 and the inner frame 522 are, for example, cylindrical members, and the bottom plate 523 is, for example, an annular member. The outer frame 521 corresponds to the frame member 12 shown in FIG. 1. The bottom plate 523 is connected to an inner peripheral surface of the outer frame 521 and a lower end of the inner frame 522. An upper end of the inner frame 522 is connected to the front plate 11. The frame member 52 has a structure in which the vibrator 19 (specifically, the diaphragm 13) does not contact the space division member of the frame member 52. Specifically, the length of the inner frame 522 is shorter than the length of the outer frame 521, thereby providing a gap between the bottom plate 523 and the diaphragm 13. The inner frame 522 and the bottom plate 523 divide the internal space 91 into internal spaces 911 and 912. The internal space 911 is a space surrounded by the front plate 11, the frame member 52, and the vibrator 19, and faces the vibrator 19. The internal space 912 is a space surrounded by the front plate 11 and the frame member 52. The internal space 912 is a space separated from the internal space 911, and is isolated from the vibrator 19. The internal space 912 is provided so as to surround the internal space 911, that is, the internal space 912 is located outside the internal space 911. Note that the internal space 912 may be located inside the internal space 911.

Some of the sound holes 111 function as paths through which sound generated in the external space enters the internal space 911, and the remaining sound holes 111 function as paths through which sound generated in the external space enters the internal space 912.

In the sound absorption apparatus 50 having the above-described configuration, the structure forming the internal space 911 and the internal space 92 functions as the Helmholtz resonator of the two-degree-of-freedom system as described above with reference to the sound absorption apparatus 10. Furthermore, the structure forming the internal space 912 functions as the Helmholtz resonator of the one-degree-of-freedom system. The sound absorption apparatus 50 has a structure in which a Helmholtz resonator is added to the sound absorption apparatus 10, and can suppress the valley characteristic between the two sound absorption coefficient peaks using the additional Helmholtz resonator.

The sound absorption apparatus 50 can be used as each of a plurality of sound absorption units forming the acoustic metamaterial.

### EXAMPLES

To show sound absorption performance of the sound absorption apparatus according to the above-described embodiment, results of measuring sound absorption characteristics of sound absorption apparatuses according to examples and results of measuring sound absorption characteristics of sound absorption apparatuses according to comparative examples will be described.

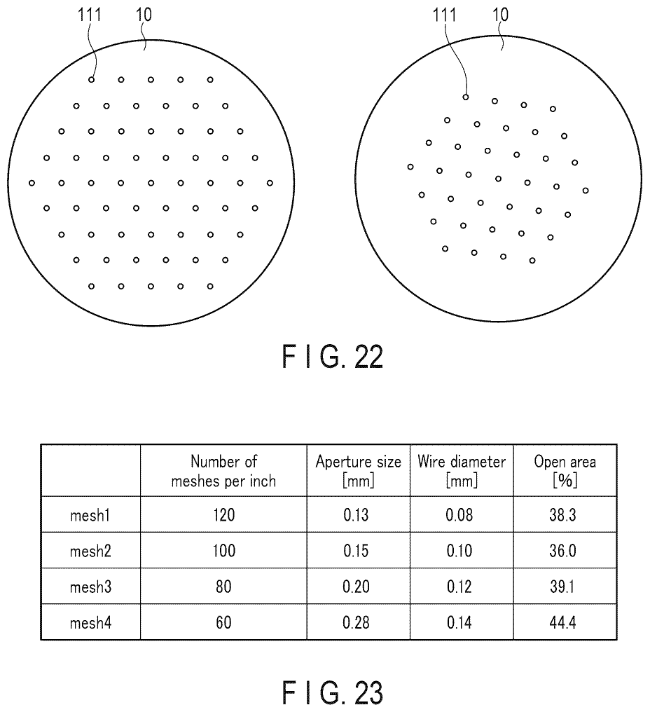

In the examples, two types of front plates 11 shown in FIG. 22 are used. The front plate 11 shown on the left side of FIG. 22 has 61 sound holes 111, and the front plate 11 shown on the right side of FIG. 22 has 37 sound holes 111. Both of the two types of front plates 11 have a diameter of 60 mm and a thickness of 1 mm. Each sound hole 111 has a diameter of 1 mm and a thickness of 1 mm.

In the examples, four types of mesh members shown in FIG. 23 are used. All of the four types of mesh members are woven wire meshes shown in FIGS. 7 and 8. A mesh member denoted as mesh 1 has 120 meshes per inch, an aperture size of 0.13 mm, a wire diameter of 0.08 mm, and an open area of 38.3%. A mesh member denoted as mesh 2 has 100 meshes per inch, an aperture size of 0.15 mm, a wire diameter of 0.10 mm, and an open area of 36.0%. A mesh member denoted as mesh 3 has 80 meshes per inch, an aperture size of 0.20 mm, a wire diameter of 0.12 mm, and an open area of 39.1%. A mesh member denoted as mesh 4 has 60 meshes per inch, an aperture size of 0.28 mm, a wire diameter of 0.14 mm, and an open area of 44.4%.

Furthermore, in the examples, a heat-resistant silicon film having a thickness of 0.5 mm is used as the diaphragm 13. The thickness of the frame member 14 is 3 mm. The central member 15 is a plastic member having a diameter of 20 mm and a thickness of 3 mm. The thickness of the back plate 18 is 3 mm.

Structures of the sound absorption apparatuses according to the comparative examples will be briefly described.

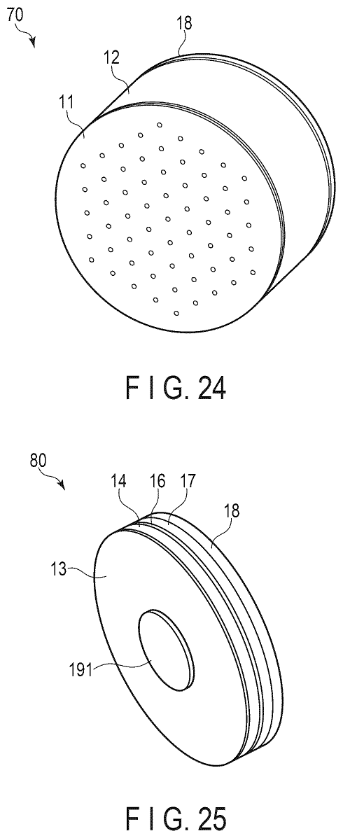

FIG. 24 schematically shows a sound absorption apparatus 70 according to a first comparative example. In FIG. 24, the same components as those shown in FIGS. 1 to 3 are denoted by the same reference numerals to omit redundant description. The sound absorption apparatus 70 shown in FIG. 24 corresponds to the sound absorption apparatus 10 from which the vibrator 19, the frame member 17, and the magnets 191 and 192 are removed. Specifically, the sound absorption apparatus 70 includes a front plate 11, a frame member 12, and a back plate 18. The front plate 11 is connected to the frame member 12 so as to close the first opening of the frame member 12, and the back plate 18 is connected to the frame member 12 so as to close the second opening of the frame member 12. The sound absorption apparatus 70 is the Helmholtz resonator of the one-degree-of-freedom system.

FIG. 25 schematically shows a sound absorption apparatus 80 according to a second comparative example. In FIG. 25, the same components as those shown in FIGS. 1 to 3 are denoted by the same reference numerals to omit redundant description. The sound absorption apparatus 80 shown in FIG. 25 corresponds to the sound absorption apparatus 10 from which the front plate 11 and the frame member 12 are removed. Specifically, the sound absorption apparatus 80 includes a vibrator 19, a frame member 17, a back plate 18, and magnets 191 and 192.

A sound absorption apparatus according to a third comparative example (not shown) corresponds to the sound absorption apparatus 30 from which the front plate 11 and the frame member 12 are removed.

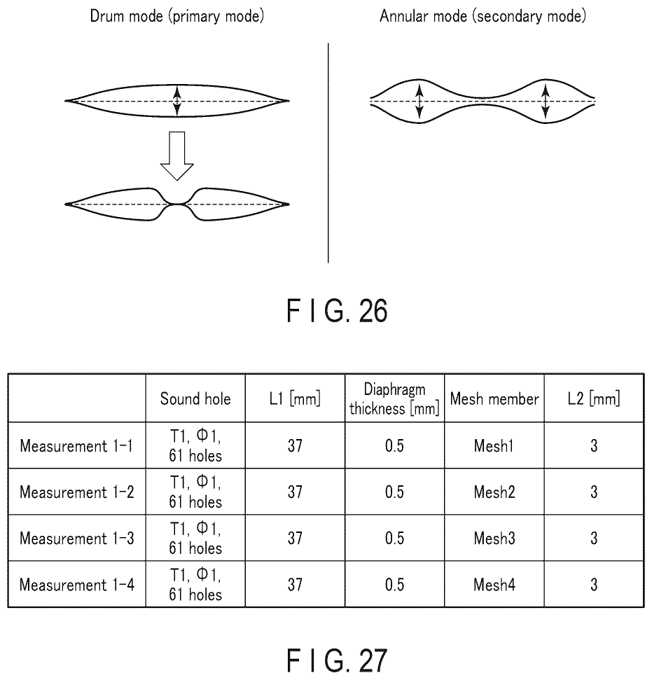

FIG. 26 shows two of various modes of vibration generated in the diaphragm 13. The vibration modes shown in FIG. 26 are vibration modes that are easily excited by sound waves incident on the diaphragm 13. Specifically, the vibration mode shown on the left side is a primary mode in which the number of nodal diameters is 0 and the number of nodal circles is 1, and the vibration mode shown on the right side is a secondary mode in which the number of nodal diameters is 0 and the number of nodal circles is 2. The primary mode is also referred to as a drum mode, and the secondary mode is also referred to as an annular mode.

In a first example, a second example, a third example, and a fifth example to be described below, the annular mode is coupled with Helmholtz resonance, and in a fourth example, the drum mode and the annular mode are coupled with Helmholtz resonance.

Since the central member 15 is attached to the central portion of the diaphragm 13, it is assumed that the drum mode is deformed into a mode shape as shown in FIG. 26. The natural frequency of each mode can be adjusted based on the diameter of the central member 15 and the material, thickness, and diameter of the diaphragm 13.

The first example corresponds to the sound absorption apparatus 10 adopting the settings (Measurement 1-1 to 1-4) shown in FIG. 27. As shown in FIG. 27, a change is made only in the mesh member 16 in Measurement 1-1 to 1-4.

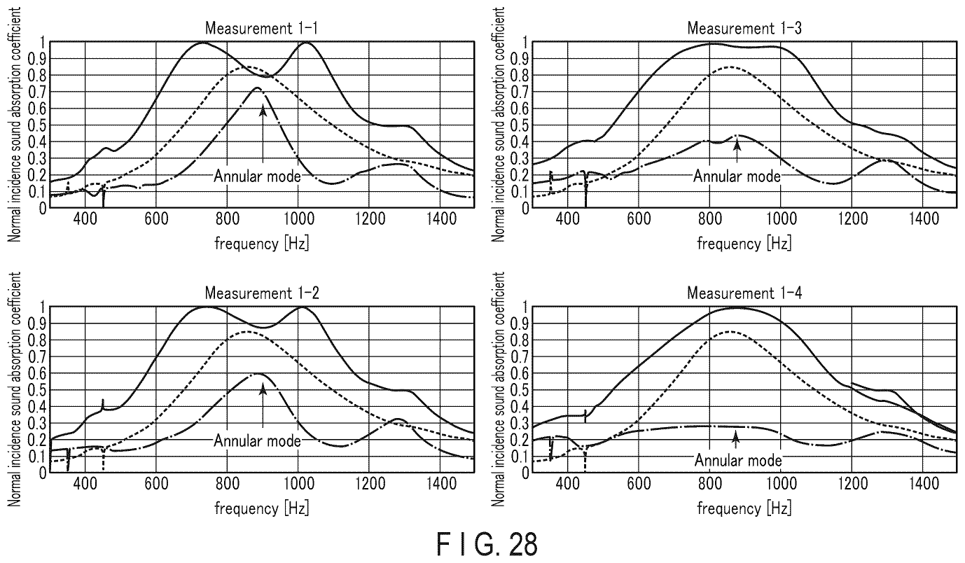

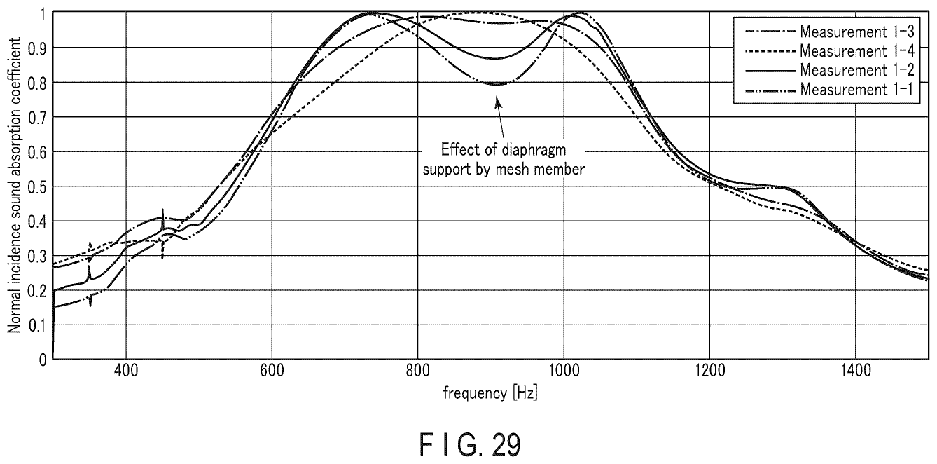

FIGS. 28 and 29 show results of measuring normal incidence sound absorption coefficients of the sound absorption apparatuses according to the first example. In FIG. 28, a solid line indicates measurement results related to the first example, a dashed line indicates measurement results related to the first comparative example, and a one-dot chain line indicates measurement results related to the second comparative example. In FIG. 29, the measurement results related to the first example are shown for comparison.

From FIG. 28, it can be confirmed that, as the wire diameter of the mesh member 16 is increased, a sound absorption coefficient peak obtained by the vibrator 19 decreases (comparison of the measurement results related to the second comparative example indicated by the one-dot chain line), and a damping effect is appropriately applied. From FIG. 29, it can be confirmed that the valley characteristic is suppressed as the wire diameter of the mesh member 16 is increased. That is, it can be confirmed that viscoelastic support and the addition of the air viscous resistance by the mesh member 16 are effective.

In the first example, with the apparatus having a thickness of approximately 47 mm, it is possible to generate a sound absorption coefficient of 0.8 or more over a wide frequency band of 635 Hz to 1090 Hz (width: 455 Hz). In particular, as in Measurement 1-3, it is also possible to achieve a sound absorption effect close to complete sound absorption (for example, a sound absorption effect with a sound absorption coefficient of 0.9 or more) in a wide band.

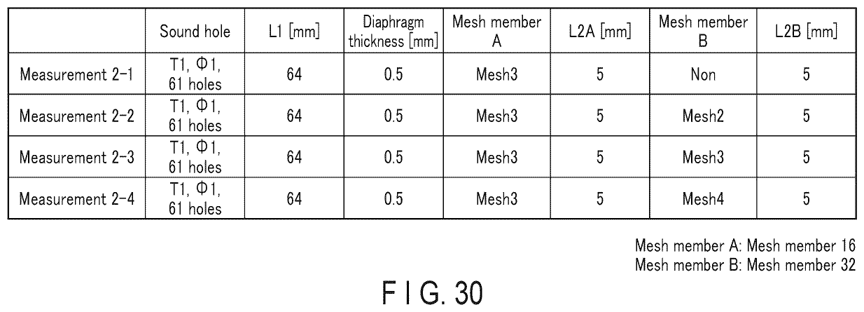

The second example corresponds to the sound absorption apparatus 30 adopting the settings (Measurement 2-1 to 2-4) shown in FIG. 30. In FIG. 30, a mesh member A indicates the mesh member 16, and a mesh member B indicates the mesh member 32. In the second example, the length L1 of the frame member 12 is longer than that in the first example. If the length L1 of the frame member 12 is increased, a center frequency of the sound absorption characteristics decreases. In Measurement 2-1 to 2-4, a change is made only in the mesh member 32.

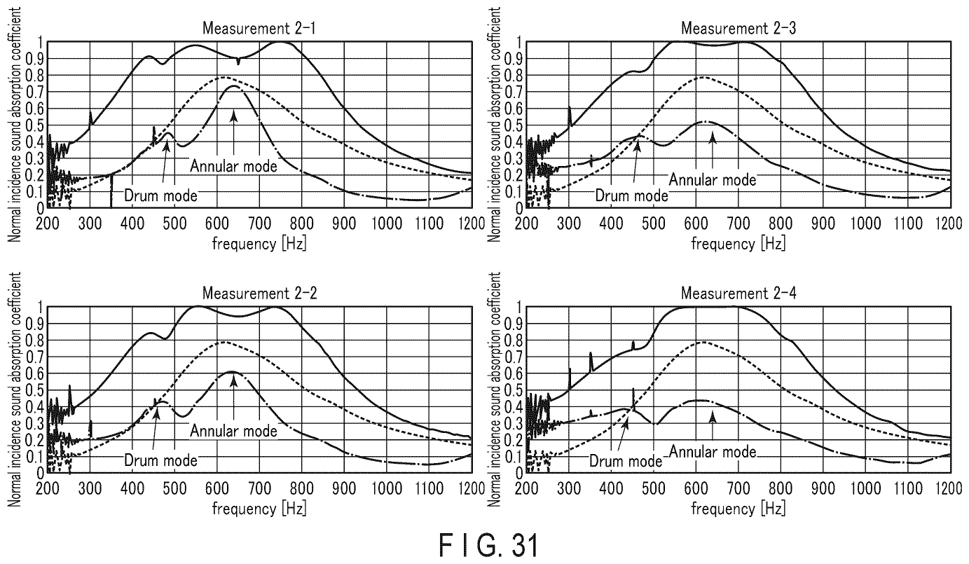

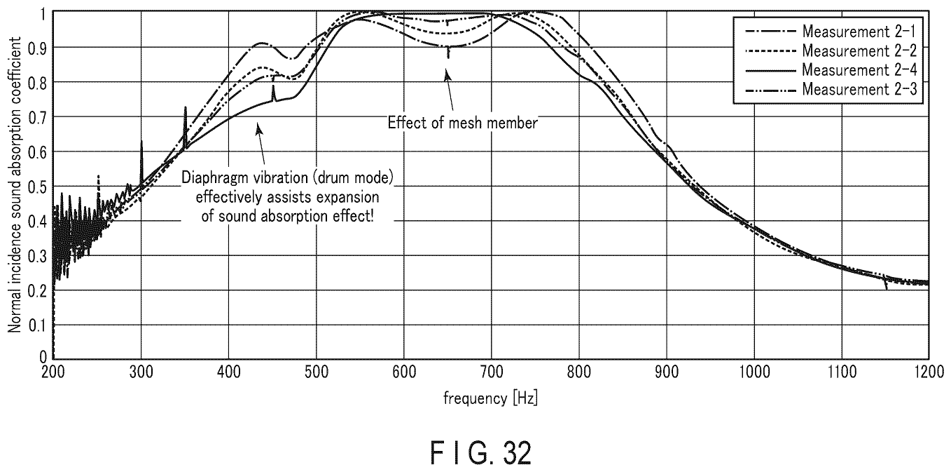

FIGS. 31 and 32 show results of measuring normal incidence sound absorption coefficients of the sound absorption apparatuses according to the second example. In FIG. 31, a solid line indicates measurement results related to the second example, a dashed line indicates measurement results related to the first comparative example, and a one-dot chain line indicates measurement results related to the third comparative example.

From FIG. 31, it can be confirmed that, as the wire diameter of the mesh member 32 is increased, the sound absorption coefficient peak obtained by the vibrator 19 decreases (comparison of the measurement results related to the third comparative example indicated by the one-dot chain line), and the damping effect is appropriately applied. From FIG. 32, it can be confirmed that the valley characteristic is suppressed as the wire diameter of the mesh member 32 is increased. That is, it can be confirmed that the addition of the air viscous resistance by the mesh member 32 is effective.

In the second example, with the apparatus having a thickness of approximately 81 mm, it is possible to generate a sound absorption coefficient of 0.9 or more over a wide frequency band of 500 Hz to 800 Hz (width: 300 Hz). In particular, as in Measurement 2-3 and 2-4, it is also possible to achieve the sound absorption effect close to complete sound absorption (for example, a sound absorption effect with a sound absorption coefficient of 0.9 or more) in a wide band.

Note that the sound absorption effect in 400 Hz to 500 Hz is caused by the drum mode of the diaphragm 13, and the drum mode effectively contributes to the expansion of the sound absorption effect in the second example. However, the assist effect of the drum mode on the sound absorption effect decreases as the wire diameter of the mesh member 32 increases. That is, the effect of the mesh member 32 on valley suppression and the assist effect of the drum mode are in a trade-off relationship.

In the second example, the mesh member 32 may not be provided to increase the sound absorption effect in 400 to 500 Hz, and the mesh member 32 may be provided to bring the sound absorption effect in 600 to 700 Hz close to complete sound absorption.

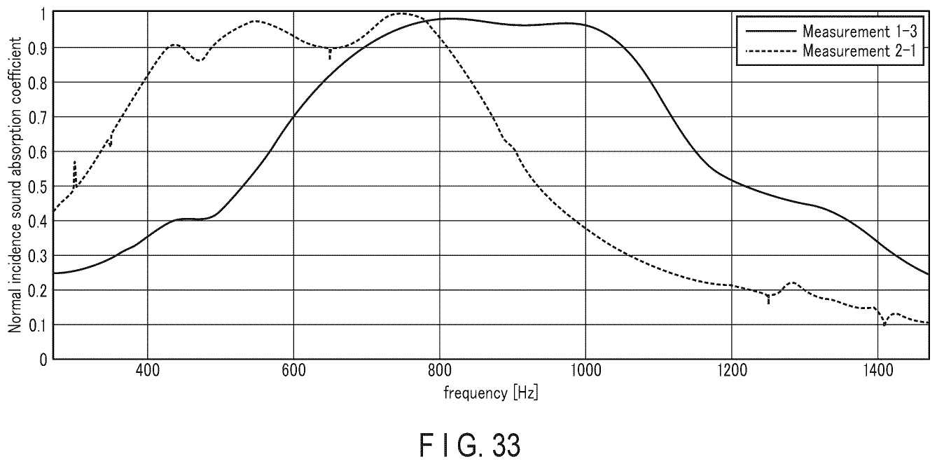

FIG. 33 shows sound absorption performance of the sound absorption apparatus (Measurement 1-3) according to the first example and sound absorption performance of the sound absorption apparatus (Measurement 2-1) according to the second example. From FIG. 33, it can be confirmed that increasing the length L1 of the frame member 12 lowers the frequency band in which the sound absorption effect can be obtained. In addition, if these apparatuses are combined and arranged side by side (for example, arranged alternately) as shown in FIG. 11, a sound absorption characteristic of 0.8 or more is obtained in a wide frequency band of 400 Hz to 1100 Hz.

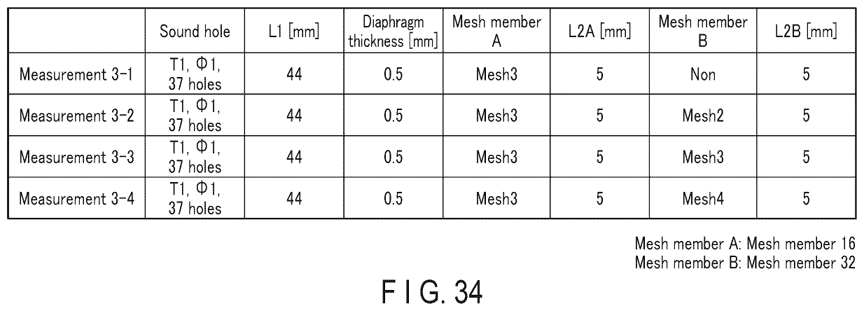

The third example corresponds to the sound absorption apparatus 30 adopting the settings (Measurement 3-1 to 3-4) shown in FIG. 34. In FIG. 34, a mesh member A indicates the mesh member 16, and a mesh member B indicates the mesh member 32. In the third example, the number of sound holes is smaller and the length L1 of the frame member 12 is shorter than that in the second example. Specifically, in the second example, the number of sound holes is 61 and the length L1 is 64 mm, whereas in the third example, the number of sound holes is 37 and the length L1 is 44 mm (shortened by 20 mm as compared with the second example). In Measurement 3-1 to 3-4, a change is made only in the mesh member 32.

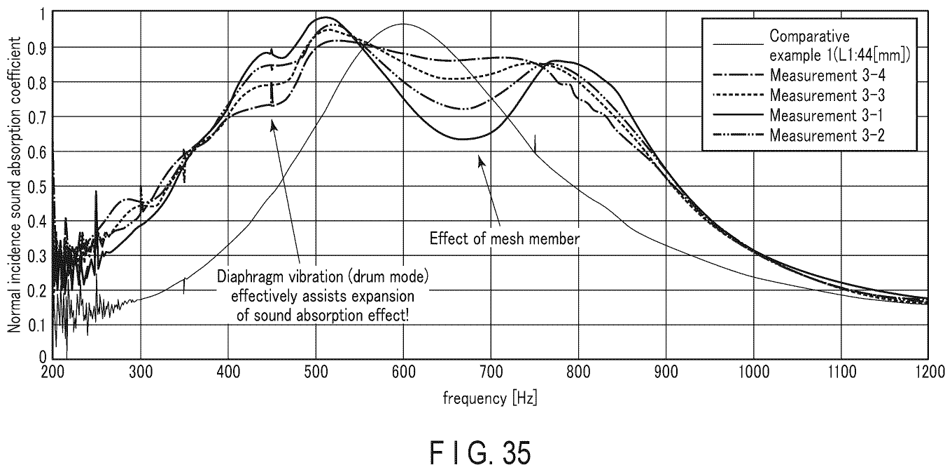

FIG. 35 shows results of measuring normal incidence sound absorption coefficients of the sound absorption apparatuses according to the third example. From FIG. 35, it can be confirmed that the valley characteristic is suppressed as the wire diameter of the mesh member 32 is increased. In addition, in the third example, it can be confirmed that the effect of the mesh member 32 is more clearly produced than in the second example, and the valley characteristic can be more effectively suppressed.

In the third example, with the apparatus having a thickness of approximately 61 mm as shown in Measurement 3-3, it is possible to generate a sound absorption coefficient of 0.8 or more over a wide frequency band of 430 Hz to 800 Hz (width: 470 Hz).

In the third example, the sound absorption effect slightly decreases as compared with the second example, but as in the second example, the effect of the mesh member 32 on suppressing the valley characteristic in the frequency band of 600 Hz to 700 Hz and the assist effect of the drum mode (diaphragm vibration) can be confirmed. It should be noted that a high sound absorption effect can be obtained over a wide band of 400 Hz to 800 Hz from the apparatus having a thickness of approximately 61 mm.

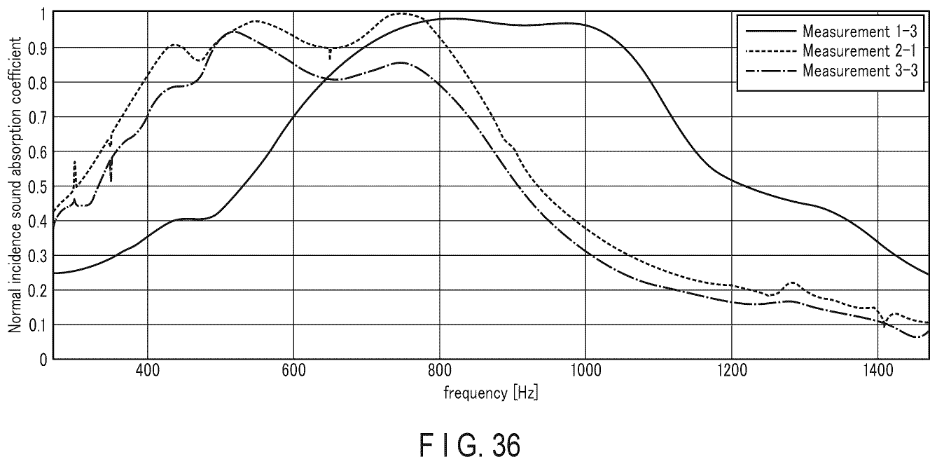

FIG. 36 shows sound absorption performance of the sound absorption apparatus (Measurement 2-1) according to the second example and sound absorption performance of the sound absorption apparatus (Measurement 3-3) according to the third example. From FIG. 36, it can be confirmed that, even if the number of sound holes is reduced to shorten the length L1 of the frame member 12, it is possible to maintain the frequency band in which the sound absorption coefficient of 0.8 can be obtained due to the effect of the mesh member 32.

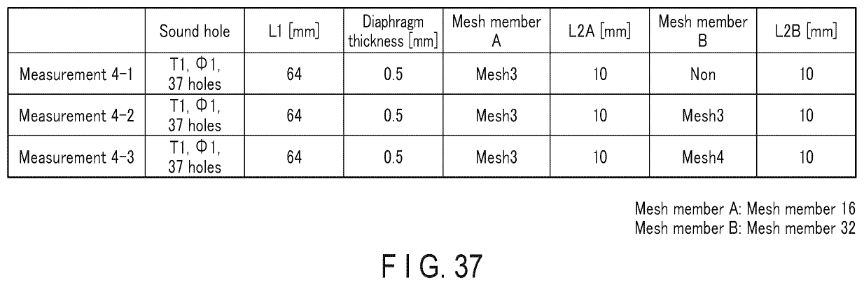

The fourth example corresponds to the sound absorption apparatus 30 adopting the settings (Measurement 4-1 to 4-3) shown in FIG. 37. In FIG. 37, a mesh member A indicates the mesh member 16, and a mesh member B indicates the mesh member 32. In the fourth example, the length L1 of the frame member 12, the length L2A of the frame member 31, and the length L2B of the frame member 33 are longer than those in the third example. If the length L1 of the frame member 12 is increased, a center frequency of the sound absorption characteristics decreases. In Measurement 4-1 to 4-3, a change is made only in the mesh member 32.

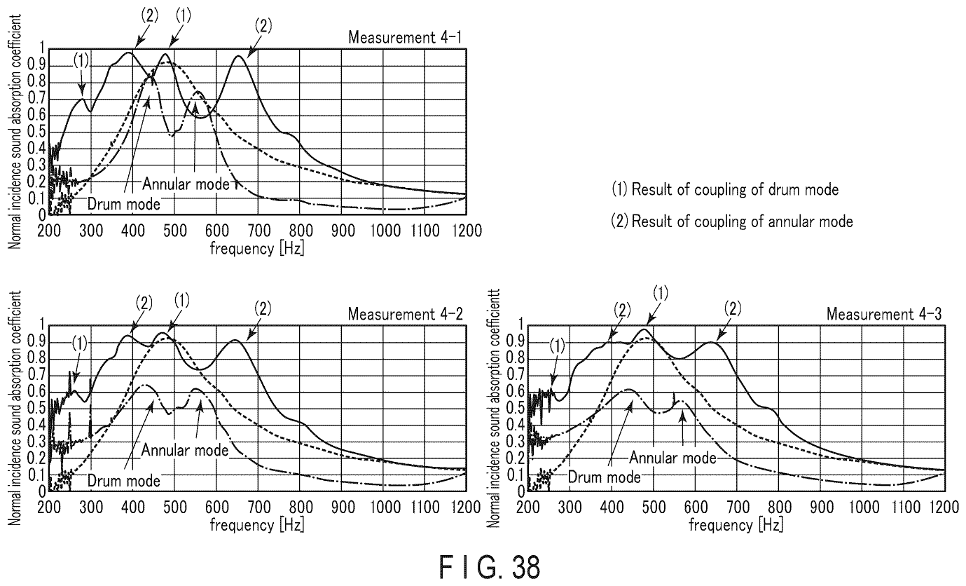

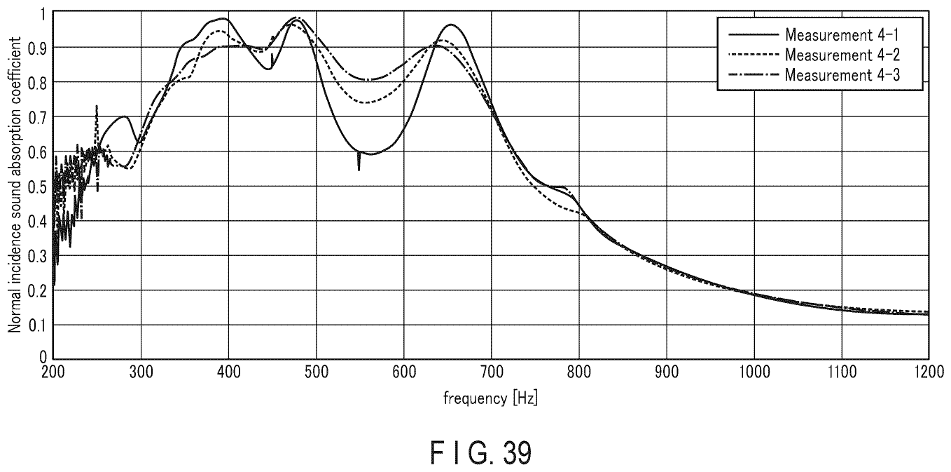

FIGS. 38 and 39 show results of measuring normal incidence sound absorption coefficients of the sound absorption apparatuses according to the fourth example. Since the lengths L2A and L2B are doubled from those in the third example, the frequency generated in the drum mode becomes close to the frequency generated in the annular mode, and as shown in FIG. 38, the drum mode and the annular mode are each coupled with the Helmholtz resonance, generating a total of four sound absorption coefficient peaks. From FIG. 39, it can be confirmed that the valley characteristic between the two sound absorption coefficient peaks obtained from the coupling of the annular mode and the Helmholtz resonance is suppressed as the wire diameter of the mesh member 32 increases. In this manner, it is also possible to simultaneously couple the two vibration modes of the diaphragm 13 with the Helmholtz resonance.

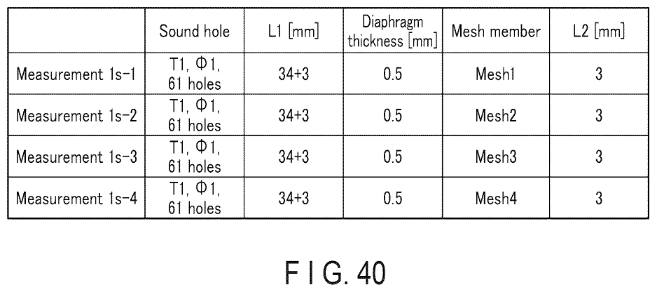

The fifth example corresponds to the sound absorption apparatus 50 adopting the settings (Measurement 1s-1 to 1s-4) shown in FIG. 40. The length L1 of the frame member 52 is 37 mm, and there is a gap of 3 mm between the space division member (specifically, the bottom plate 523) and the diaphragm 13. The difference between Measurement 1s-1 to 1s-4 and Measurement 1-1 to 1-4 is only the structure of the frame member.

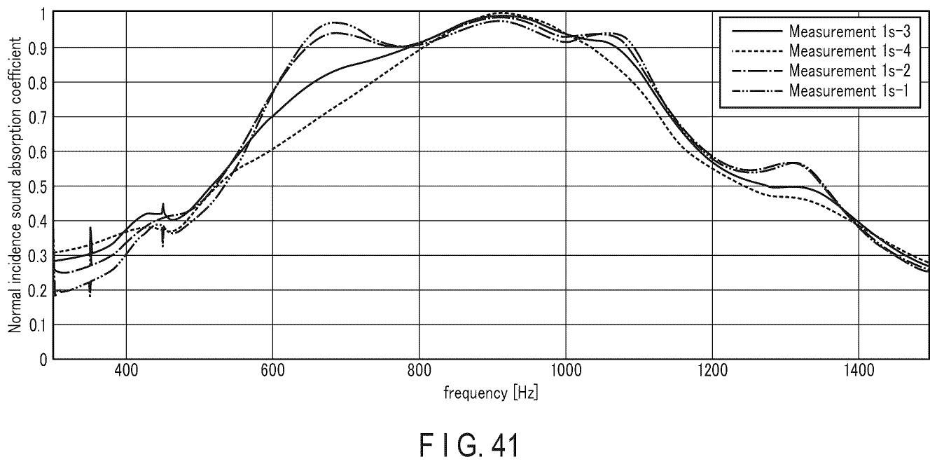

FIG. 41 shows results of measuring normal incidence sound absorption coefficients of the sound absorption apparatuses according to the fifth example. In the fifth example, the effect of suppressing the valley characteristic is obtained not only from the mesh member 16 but also from the structure of the frame member 52. For this reason, as shown in FIG. 41, if the wire diameter of the mesh member 16 is increased, the effect of suppressing the valley characteristic becomes too strong, which may result in a narrower bandwidth in which a high sound absorption effect can be obtained. Therefore, in the sound absorption apparatus 50, the mesh member 16 is sufficient to function as a support member that elastically supports the diaphragm 13 via the central member 15 as in mesh 1 (Measurement 1s-1), and may have the structure configured to add a small air viscous resistance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sound absorption apparatus comprising:
a front plate including a sound hole;
a diaphragm facing the front plate;
a first frame member connected to the front plate and the diaphragm, the first frame member forming a first space between the front plate and the diaphragm;
a central member connected to a central portion of the diaphragm;
a first mesh member including a plurality of openings, the first mesh member being connected to the central member;
a second frame member connected to the diaphragm and the first mesh member, the second frame member forming a second space between the diaphragm and the first mesh member;
a back plate facing the first mesh member; and
a third frame member connected to the first mesh member and the back plate, the third frame member forming a third space communicating with the second space via the openings of the first mesh member between the first mesh member and the back plate.

2. The sound absorption apparatus according to claim 1, further comprising
a second mesh member including a plurality of openings through which air passes, wherein
the third frame member includes a fourth frame member and a fifth frame member,
the second mesh member is provided between the fourth frame member and the fifth frame member, and
the third space is divided by the second mesh member into a fourth space and a fifth space communicating with the fourth space via the openings of the second mesh member.

3. The sound absorption apparatus according to claim 1, wherein
the first mesh member is configured to support the central member so as to vibrate with respect to the second frame member.

4. The sound absorption apparatus according to claim 2, wherein
the first mesh member is configured to support the central member so as to vibrate with respect to the second frame member.

5. The sound absorption apparatus according to claim 1, wherein
the second frame member is a cylindrical member, and
the first mesh member is a circular member having an outer diameter equal to an outer diameter of the second frame member.

6. The sound absorption apparatus according to claim 2, wherein
the second frame member is a cylindrical member, and
the first mesh member is a circular member having an outer diameter equal to an outer diameter of the second frame member.

7. The sound absorption apparatus according to claim 1, wherein
the first mesh member includes a woven wire mesh.

8. The sound absorption apparatus according to claim 2, wherein
the first mesh member includes a woven wire mesh.

9. The sound absorption apparatus according to claim 2, wherein
the second mesh member includes a woven wire mesh.

10. The sound absorption apparatus according to claim 1, further comprising a pair of magnets, wherein
the diaphragm, the central member, and the first mesh member are arranged between the pair of magnets.

11. The sound absorption apparatus according to claim 2, further comprising a pair of magnets, wherein
the diaphragm, the central member, and the first mesh member are arranged between the pair of magnets.

12. The sound absorption apparatus according to claim 2, wherein
the fourth frame member and the fifth frame member are cylindrical members, and
the second mesh member is a circular member having an outer diameter equal to outer diameters of the fourth frame member and the fifth frame member.

13. The sound absorption apparatus according to claim 1, wherein
the first frame member includes a space division member configured to divide the first space into a space facing the diaphragm and a space isolated from the diaphragm.

14. The sound absorption apparatus according to claim 13, wherein
a gap is provided between the diaphragm and the space division member so as to prevent the diaphragm from contacting the space division member.
